(19) United States
(12) Patent Application Publication
(10) Pub. No.: US 2022/0295939 A1
(43) Pub. Date: Sep. 22, 2022

(54) MAGNETIC PROPULSION INSOLE FOR LOCATION IN AN USER SHOE

(71) Applicant: KADDUX S.A.S., Bogota (CO)

(72) Inventor: Maria Carolina REYES, Bogota (CO)

(21) Appl. No.: 17/275,812

(22) PCT Filed: Aug. 21, 2020
(86) PCT No.: PCT/IB2020/057845

§ 371 Date: Mar. 12, 2021

(30) Foreign Application Priority Data
Sep. 25, 2019 (CO) NC2019/0010387

(51) Int. Cl. A43B 7/32; A43B 13/14; A43B 17/02; A43B 17/04

(52) U.S. Cl. CPC A43B 7/32; A43B 13/143; A43B 17/023; A43B 17/04

(57) ABSTRACT

An insole having a magnetic propulsion insert, provided with magnets or magnetic charges inside thereof, which provides a magnetic distracting effect in the midfoot and the hindfoot of a user. The insole formed by two sheets is merged in the fore third, known as the forefoot zone leaving the sheets in the midfoot zone and the hindfoot zone separated. The magnetic propulsion insert is a structure formed by a sheet which bends in its midpoint to create two separate surface and with identical magnetic charges. These generate a propulsion effect by the force or impulse produced by the magnetic charges. In the rear thirds of the insole, the top sheet has charges in its bottom surface, and in these two thirds the bottom sheet has the same charges as the top surface. This is to generate the propelling effect in the foot heel of a user.

### FIELD OF THE INVENTION

The present invention is applicable in the technical field of wellbeing, health and quality of life, namely, to an insole having a magnetic propulsion insert, provided with magnets generating a magnetic effect which at repelling, its identical charges provide comfort at walking, facilitating the heel take off and diminishing the load on the heel.

### BACKGROUND OF THE INVENTION

The health of feet is the basis of the balance in joints of lower limbs and the spine generating thereby wellbeing and improving the quality of life of human beings.

Insoles are known to be designed such that they support the different foot zones, such as, e.g. insoles with metatarsal button or bar, scaphoid pad and insoles with inner or outer heel enhancements. Insoles which stimulate certain areas of the foot sole are also known.

More particularly, the invention refers to an insole, being provided with some surface with identical magnetic charges to produce a propellant effect on the midfoot (arch) and the hindfoot (heel) so as to facilitate the heel take off during walking or running, improving the efficiency and reducing the effort and the joint wear, due to the presence of the propellant force.

The object of the invention is to create a magnetic propulsion insole to be worn inside the shoe of a user, which has two sheets between which an insert containing magnets or sheets with identical magnetic charges is located. Such an insert encompasses the midfoot and hindfoot areas to facilitate the heel take off, reducing the foot fatigue and the joint wear due to the distracting force existing between the magnetic sheets. The insole may extend over the entire surface of the shoe sole or only from the heel part to the midfoot are, such as a heel counter.

### DETAILED DESCRIPTION OF THE DRAWINGS

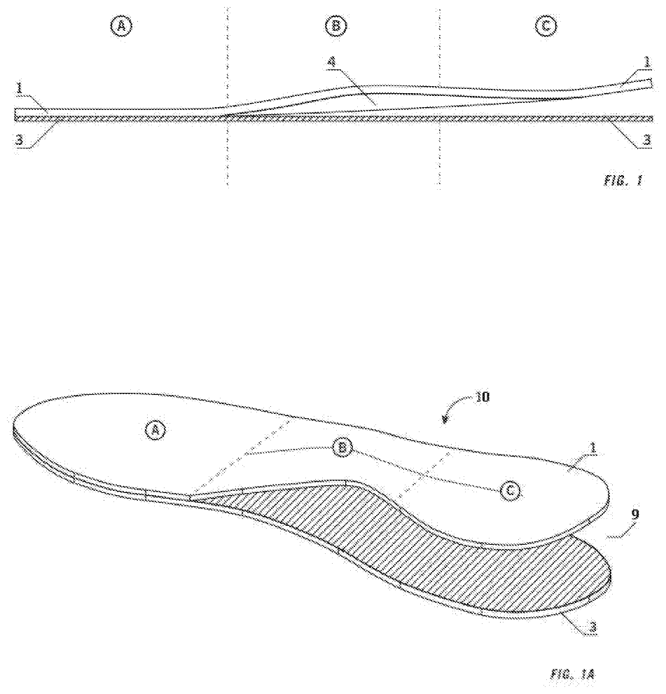

FIGS. 1 and 1A. Side and perspective views of the assembly of the insole of the present invention.

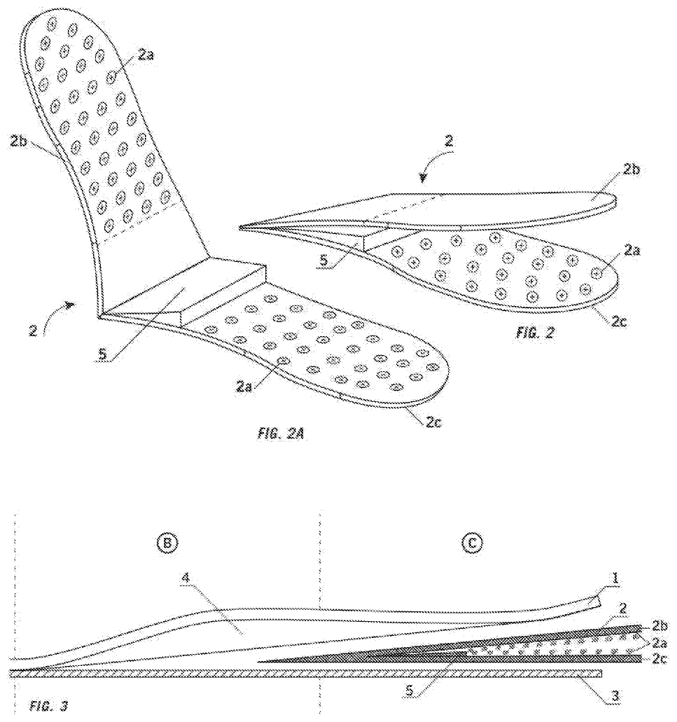

FIGS. 2 and 2A. Perspective views of the insole insert of the present invention, with optional support wedge (5).

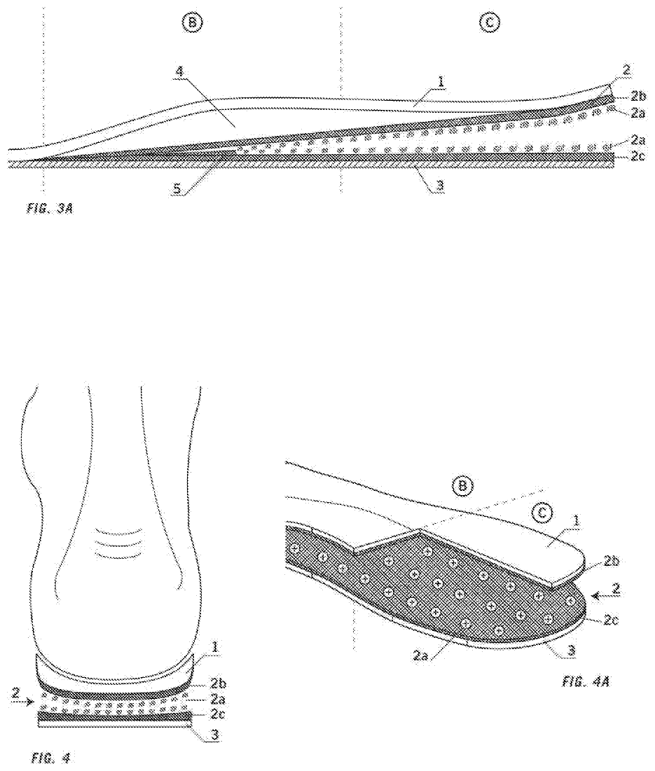

FIGS. 3 and 3A. Side views of the insole with the insert in the midfoot (B) and hindfoot (C) areas.

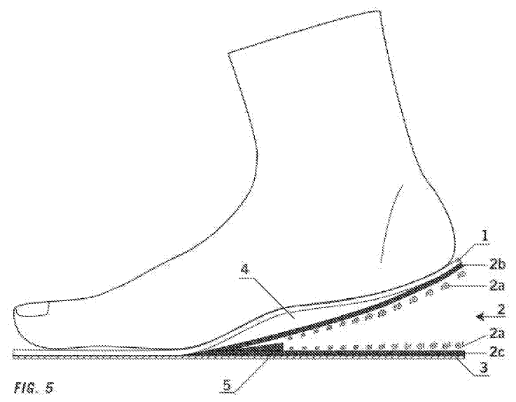

FIG. 4. Rear view of the insole in the foot heel of a user.

FIG. 4A. Perspective and cross-section views of the magnetic propulsion insert in the insole of the present invention.

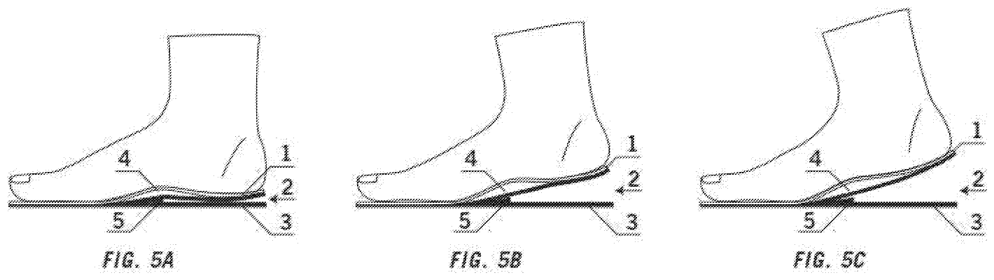

FIG. 5. Side view of the insole in the foot sole of a user with optional support wedge (5).

FIGS. 5A-5B-5C. Illustrate the propellant effect generated by the magnetic charges of the insert of the insole of the present invention.

### DETAILED DESCRIPTION OF THE INVENTION

FIGS. 1-1A depict an insole (10), which is a complete structure covering all the foot sole, formed by two sheets, a top one (1) and a bottom one (3), which are merged in the forefoot area (A), leaving the midfoot (B) and the hindfoot (C) areas separated. In the top sheet (1) there is a pad (4) covering the midfoot area (B) and a section of the hindfoot zone (C), in order to provide an improved comfort and damping for the arch and the heel of the user's foot. Sheets (1, 3) and/or the pad (4) are made of different materials which provide endurance, reaction ability, durability and it is also hygienic, breathable and lightweight. Some of the options for materials are: carbon fiber (low weight and thickness), polypropylene (thermo adaptable, high durability), polycarbonate, EVA: ethyl vinyl acetate (hardness), fiberglass (flexibility), gelfoam, silicone or a combination thereof.

In FIG. 1A between the midfoot area (B) towards the hindfoot area (C), an open area (9) is created to accommodate a magnetic propulsion insert (not shown).

The preferred embodiment of the invention is illustrated in the appended drawing: FIG. 1 shown an insole extending over the entire surface of the sole and in another embodiment (not shown), the insole extends only from the hindfoot area (C) to the midfoot area (B).

Between the midfoot area (b) towards the hindfoot area (C), an open area (9) is created to accommodate a magnetic propulsion insert (21) as shown in FIGS. 2 and 2A. The insert (2) is a structure formed by a sheet which bends at its midpoint to create to separate surfaces, a top surface (2b) and a bottom surface (2c) symmetrically equal. In an embodiment of the invention, said surfaces (2b, 2c) contained adhered thereto a plurality of magnets (2a) in a predetermined pattern but identical in both surfaces, wherein the magnetic charges of said magnets (2a) in both surfaces (2b, 2c) are identical, generating a propellant effect by the force or impulse produced by the magnetic charges at being repelled. Wherein the magnets or the magnetic sheets (2a) are high power of the Neodymium type, among others.

In an embodiment, the surfaces (2b, 2c) have a flange along the outline or periphery of the surface to avoid contact between both surfaces (2b, 2c). Wherein said flange is made of a low-density polymer material, such as silicone, etc.

In the preferred embodiment of the invention, optionally, a rigid or semi-rigid support (support wedge) is accommodated between the bottom (2c) and top (2b) surfaces in the form of a wedge (5) to avoid the contact of the two surfaces (2b, 2c) at the initial moment of walking in the support phase of the heel and subsequently, would provide an effect or improved propulsion exerted forwards during walking. This wedge (5) may be manufactured in different materials, such as Gelfoam, silicone, rubber, among others.

In another embodiment of the invention, the insert (2) sheet is a flexible, semi-rigid and magnetizable material which may be manufactured in different magnetic materials which provide sufficient magnetic force. Some of the options for materials are: Steel, Cold Roll, Stainless Steel, Strip, among others. Wherein both surfaces of the sheet are magnetized with the same magnetic charge.

FIGS. 3-3A illustrate the location of the insert (2) in the insole of the present invention (10), wherein it is accommodated between the sheets (1) and (3) extending along the midfoot zone (B) and the hindfoot zone (C), wherein said insert (2) besides of having a magnetic propulsion effect, it works as a damping base for the insole (10) in order to provide a greater comfort and damping for the user foot, namely for the arch and the heel of the foot.

Referring to FIGS. 4-4A, it can be seen the part of the hindfoot (C) at the time of support of the foot heel on the insole (10), wherein the surfaces (2b, 2c) of the insert (2) with identical charges, are not in contact by the propulsion force produced by the magnetic charges (2a) located over the top (2b) and bottom (2c) surfaces in the midfoot (B) and hindfoot (C) areas. In the preferred embodiment of the invention, the insert (2) is removable from the insole (10), while in another embodiment, optionally, said insert (2) is adhered or fixed to the inner surfaces of the sheets (1) and (3) of the insole (10) through some fixation means, such as adhesive.

Referring to FIGS. 5 and 5A-5C, it can be seen a side view of the insole (10) on the foot sole of a user when the foot heel of the user is lifted by the effect of propulsion. By having a propellant effect, the insole (10) improves the efficiency during walking, generates greater comfort, reduces the impact and stress over the hindfoot, producing a “levitation” sensation. Wherein an object of the present invention is that the insole (10) works when supporting the heel, or initial walking phase, by approaching the two sheets (1) and (3) in the hindfoot area (C) of the insole in a damped manner and then, in the lifting phase of the heel where the magnetic forces favor the propulsion force, reducing the muscle effort. Another object of the present invention is the magnetic propulsion effect generated by the charges of the insole insert.

The present invention has been described for illustrative purposes, not limitative, according to the preferred embodiments, but it should be understood that those skilled in the art may introduce modifications and/or changes without departing from the relevant scope, as defined in the appended claims.

1. An insole for a shoe sole of a user, comprising:
a first zone supporting the forefoot of the user;
a second zone supporting the midfoot of the user;
a third zone supporting the hindfoot of the user;
wherein the insole further comprises:
a top sheet where a pad is accommodated which supports the midfoot zone and a section of the hindfoot zone providing damping for the foot arch and heel of the user; and
a bottom sheet which is merged with the top sheet in the forefoot zone , leaving the midfoot zone and the hindfoot zone separated.

2. The insole according to claim 1, wherein the top and bottom sheets are made of different materials selected from the group consisting of: carbon fiber, polypropylene, polycarbonate, EVA (ethyl vinyl acetate), fiberglass, gelfoam, silicone, or a combination thereof.

3. The insole according to claim 1, wherein the insole extends over the entire surface of the shoe sole.

4. The insole according to claim 1, wherein the insole extends only from the hindfoot zone to the midfoot zone of the shoe sole.

5. The insole according to claim 1, further comprising a cavity between the midfoot zone towards the hindfoot zone of the sole which accommodates a magnetic propulsion insert.

6. The insole according to claim 5, wherein the magnetic propulsion insert is a structure formed by a sheet being bent in its midpoint to create to separate surfaces, a top surface and a bottom surface symmetrically equal.

7. The insole according to claim 6, wherein said top surface and bottom surface have a flange in its contour to avoid contact between both surfaces.

8. The insole according to claim 6, wherein said insert sheet is a flexible, semi-rigid and magnetizable material selected from the group consisting of: steel, cold roll, stainless steel, strip, and a combination thereof.

9. The insole according to claim 6, wherein the top and bottom surfaces have adhered thereto a plurality of magnets in a determined pattern, but identical in both surfaces.

10. The insole according to claim 6, wherein the material in both surfaces of the sheet is magnetized with the same magnetic charge.

11. The insole according to claim 9, wherein the plurality of magnets have identical magnetic charges in both surfaces providing a propulsion effect by the force or impulse produced by the magnetic charges at repelling.

12. The insole according to claim 9, wherein the magnets or the magnetic sheets are of high power Neodymium type.

13. The insole according to claim 6, wherein a rigid or semi-rigid support is accommodated between the bottom and top surfaces in the shape of the wedge to avoid contact of the two surfaces at the initial moment of walking in the support phase of the heel and subsequently, it would provide an improved propulsion effect exerted forward during walking.

14. The insole according to claim 13, wherein the wedge is made of a material selected from the group consisting of: gelfoam, silicone, and rubber.
